(19) United States
(12) Patent Application Publication
(10) Pub. No.: US 2013/0006756 A1
(43) Pub. Date: Jan. 3, 2013

(54) SYSTEM AND METHOD FOR PROVIDING ADVERTISEMENTS BASED ON USER'S INTENTION TO PURCHASE

(75) Inventor: Wook Heon HEO, Seongnam-si (KR)

(73) Assignee: NHN BUSINESS PLATFORM CORPORATION, Seongnam-si (KR)

(21) Appl. No.: 13/340,846

(22) Filed: Dec. 30, 2011

(30) Foreign Application Priority Data
Dec. 30, 2010 (KR) 10-2010-0139460

(51) Int. Cl. G06Q 30/02

(52) U.S. Cl. 705/14.45; 705/14.69; 705/14.54

(57) ABSTRACT

Provided is a system and method for providing advertisements. The system may include a user identification unit to identify a user with an intention to make a purchase, a bidding unit to receive a bid for a right to offer an advertisement of an advertiser for a product or service to the user, a storage device to contain an advertisement database to store an identification (ID) of the advertisement, and an advertisement provision unit to provide the user with the advertisement of the advertiser.

### CROSS-REFERENCE TO RELATED APPLICATION

This application claims priority from and the benefit of Korean Patent Application No. 10-2010-0139460, filed on Dec. 30, 2010, which is hereby incorporated by reference for all purposes as if fully set forth herein.

### BACKGROUND OF THE INVENTION

1. Field of the Invention

Exemplary embodiments of the present invention relate to a system and method for providing advertisements based on a user group, and more particularly, to a system and method for providing advertisements that may identify a user group with an intention to make a purchase of a product or service, and may provide the user group with an advertisement.

2. Discussion of the Background

Thanks to the active use of electronic commerce, more and more products and services are sold through keyword advertisements. For example, when a user inputs a keyword to request a search, keyword advertisements corresponding to the keyword may be provided as a search result through a search site. The user may visit a web site the user is interested in among the search result, and may purchase a desired product or service from the web site.

In this instance, to increase an effect of keyword advertisements, a more accurate targeting method is required. For example, when a search engine provides a targeted keyword advertisement to all users who enter keywords to request a search, an advertizing effect may be reduced. This is because a user may not purchase a product or service through a keyword advertisement, even when the user requests a search.

Accordingly, there is a desire for a detailed method on how to classify users to increase a targeting effect of keyword advertisements.

### SUMMARY OF THE INVENTION

Exemplary embodiments of the present invention provide a system and method that may identify a user group with an intention to make a purchase of a product or service, and may increase a targeting effect for a keyword advertisement of an advertiser.

Exemplary embodiments of the present invention also provide a system and method that may perform a bid between advertisers with respect to an identified user group, and may grant a right to provide a keyword advertisement to a successful advertiser who has succeeded in the bid, prior to the other advertisers, thereby to naturally induce a competitive bid to achieve an excellent advertising effect.

Exemplary embodiments of the present invention also provide a system and method that may identify a user group with an intention to make a purchase of a product or service, based on a search history, information regarding repeatedly inputting of a keyword, and conversion data, thereby to more accurately determine a user group with an intention to make a purchase for a product or service.

Additional features of the invention will be set forth in the description which follows, and in part will be apparent from the description, or may be learned by practice of the invention.

In accordance with an exemplary embodiment of the present invention, a method for providing an advertisement using a processor, is provided which includes: identifying a user, by the processor, with an intention to make a purchase, receiving a bid for a right to offer an advertisement of an advertiser for a product or service to the user, storing an identification (ID) of the advertisement into an advertisement database contained in a storage device, and providing the user with the advertisement of the advertiser.

In accordance with another exemplary embodiment of the present invention, a system for providing an advertisement is provided which includes: a user identification unit to identify a user with an intention to make a purchase, a bidding unit to receive a bid for a right to offer an advertisement of an advertiser for a product or service to the user, a storage device to contain an advertisement database to store an identification (ID) of the advertisement, and an advertisement provision unit to provide the user with the advertisement of the advertiser.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram that illustrates a configuration of an advertisement providing system according to an exemplary embodiment of the present invention.

FIG. 2 is a diagram that illustrates a process of identifying a user group according to an exemplary embodiment of the present invention.

FIG. 3 is a diagram that illustrates a process of determining whether a user has an intention to purchase a product according to an exemplary embodiment of the present invention.

FIG. 4 a diagram that illustrates a process of providing a user group with an advertisement of an advertiser according to an exemplary embodiment of the present invention.

FIG. 5 is a flowchart illustrating an advertisement provision method according to an exemplary embodiment of the present invention.

FIG. 6 is a block diagram that illustrates another configuration of an advertisement providing system according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity Like reference numerals in the drawings denote like elements.

It will be understood that when an element is referred to as being “connected to” another element, it can be directly connected to the other element, or intervening elements may be present.

Hereinafter, exemplary embodiments of the present invention will be described with reference to the accompanying drawings.

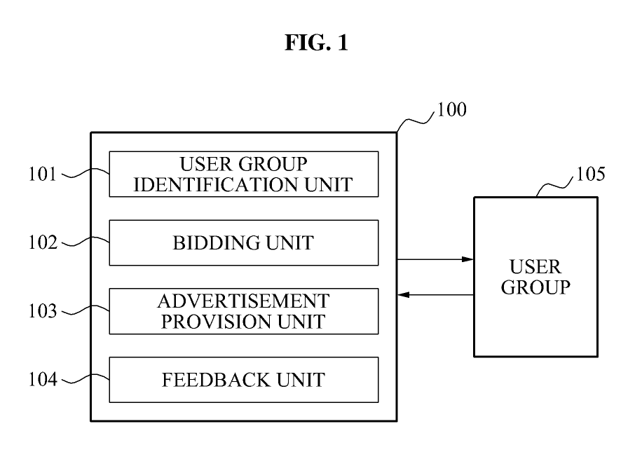

FIG. 1 is a block diagram that illustrates a configuration of an advertisement providing system 100 according to an exemplary embodiment of the present invention.

Referring to FIG. 1, the advertisement providing system 100 may include a user group identification unit 101, a bidding unit 102, an advertisement provision unit 103, and a feedback unit 104.

The user group identification unit 101 may identify a user group 105 with an intention to make a purchase for a product or service. Here, the user group 105 may include at least one user who exhibits an intention to make a purchase for a product or service. Whether a user has an intention to make a purchase may be determined based on an intention parameter which is calculated based on the user's actions in relation with the specific product or service. For example, when a user merely searches for the product or service, and actually does not purchase the product or service, the user may be determined to not have an intention to make a purchase. Additionally, when a user searches for the product or service, and purchases the product or service, the user may be determined to have an intention to make a purchase. The intention parameter may be calculated by stages in a purchase process.

The user's action of purchasing the specific product or service may mean that the user has the intention to purchase the specific product or service in certain circumstances. In other circumstances, purchasing the product or service may mean that the user does not have an intention to purchase the product or service any more. For example, an action of purchasing supplies, such as inkjet cartridges, office goods and the like, may mean that the user has a continuous intention to purchase the specific product since such product tends to be purchased repeatedly by the same consumer. Also, an action of purchasing an electronics, such as a digital camera, laptop, and the like, may mean that the user does not have an intention to purchase the products since, once the user has the purchased the products, he or she is unlikely to purchase the same type of products again in the near future.

In an exemplary embodiment, the user group identification unit 101 may identify the user group 105 based on search histories of the users for a keyword related to a product or service. Specifically, when a user enters a keyword related to a product or service and searches for the product or service multiple times, the user is more likely to belong to a user group with an intention to make a purchase for the product or service. Additionally, when a user enters a keyword related to a product or service and selects a shopping category from a search result, the user is more likely to belong to a user group with an intention to make a purchase for the product or service. Furthermore, when a user enters a keyword related to a product or service, and clicks on a sale posting on a community site in which used items are traded, the user is more likely to belong to a user group with an intention to make a purchase for the product or service, depending on the type of the product or service.

In another exemplary embodiment, the user group identification unit 101 may identify the users belonging to the specific user group 105 which corresponds to a product or service, based on at least one of whether at least one similar keyword related to the product or service has been repeatedly inputted, and the number of times the similar keywords have been repeatedly inputted.

In still another exemplary embodiment, the user group identification unit 101 may identify the users belonging to the specific user group 105 using conversion data of a user that is based on a search result associated with a keyword related to the product or service. The conversion data may include information on a series of user's actions to purchase the product or service. The user's actions may include, for example, (1) logging into a retailer site, (2) subscribing to the retailer site, (3) viewing customer comments or reviews of products or services on the retailer site, (4) recommending the product or service, a user desires to purchase, to friends on a social network, (5) scraping details of a desired product or service from the retailer site to a community site, (6) adding the product or service to a wish list of the retailer site, (7) adding the product or service to a shopping cart of the retailer site and paying for the product or service with a payment method, and the like.

To identify a user group with an intention to make a purchase for the product or service, the user group identification unit 101 may use identification information to identify users in the specific user group. The identification information may include, for example, cookie information, an Internet Protocol (IP) information, log-in information, and Media Access Control (MAC) information.

The bidding unit 102 may receive a bid for a right to offer an advertisement to the user group 105. That is, the right may be granted to a successful advertiser who has succeeded in the bid, prior to the other advertisers, namely, unsuccessful advertisers who have failed in the bid.

For example, the bidding unit 102 may receive, from one or more advertisers, a first bid for a keyword related to a product or service, and may receive a second bid from the advertisers. Here, the bid for the right may include the first bid, and the second bid. The first bid may refer to a bid for a keyword related to a product or service, and the second bid may refer to a bid for a keyword related to a user group.

Additionally, the bidding unit 102 may determine a minimum bid price for the second bid, based on a bid price received through the first bid, and may receive the second bid. Specifically, the bidding unit 102 may determine a maximum bid price received through the first bid to be the minimum bid price for the second bid.

According to an exemplary embodiment, the bidding unit 102 may maintain an advertisement database in a storage device. The advertisement database may contain a plurality of products and/or services which are targeted to be advertised through the advertisement providing system 100. The advertisement database may contain identifications (IDs) of one or more advertisements in order which will be provided to the user when the user enters the specific keyword. When there are two or more advertisements of the advertisers listed in the advertisement database for a particular product or service, only one advertisement may be qualified as a successful advertisement depending on the particular implementation. In another exemplary embodiment, advertisements of multiple advertisers may be provided to the user in a specific order determined by the advertisement provision unit 103.

The advertisement provision unit 103 may provide a user in the user group 105 with an advertisement of the successful advertiser, prior to the other advertisements, namely, advertisements of the unsuccessful advertisers. The advertisement of the successful advertiser may be associated with the second bid for the keyword related to the user group. Specifically, the advertisement provision unit 103 may arrange advertisements so that the advertisement of the successful advertiser may rank higher than the other advertisements.

The feedback unit 104 may provide the successful advertiser, as feedback, with result data regarding a result that the user in the user group 105 purchases a product or service of the successful advertiser through an advertisement provided to the user group 105. Specifically, the feedback unit 104 may utilize the conversion data of the user provided with the advertisement of the successful advertiser, as basic data to determine an intention to make a purchase for a product or service.

Thus, the advertisement providing system 100 may identify the users in a user group with an intention to make a purchase for a product or service, and may offer an advertisement that targets the user group, and accordingly an advertising effect may be increased.

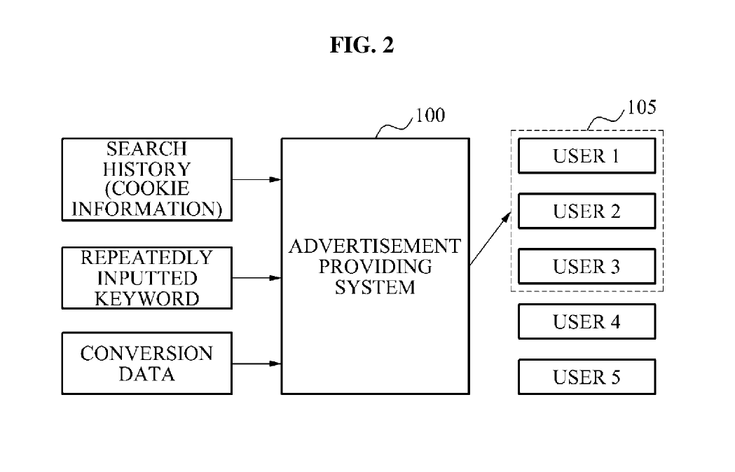

FIG. 2 is a block diagram that illustrates a process of identifying users in a user group according to an exemplary embodiment of the present invention.

The user group 105 may include users 1, 2, 3 each having an intention to make a purchase for a product or service among a plurality of users.

Referring to FIG. 2, the advertisement providing system 100 may identify the user group 105 with an intention to make a purchase, based on a search history for a keyword related to the product or service. Here, the search history may be verified based on cookie information of a user.

Additionally, the advertisement providing system 100 may identify the users in the user group 105 corresponding to the product or service, based on at least one of whether at least one similar keyword related to the product or service is repeatedly inputted, and the number of times the similar keyword is repeatedly inputted.

Furthermore, the advertisement providing system 100 may identify the users in the user group 105 using conversion data of each user that is based on a search result associated with the keyword related to the product or service.

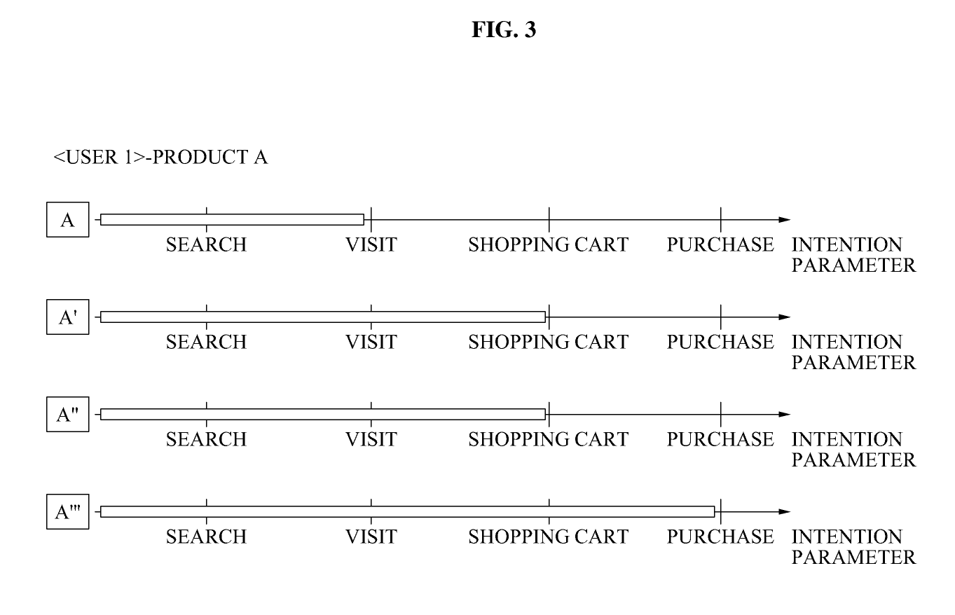

FIG. 3 is a diagram that illustrates a process of determining whether a user has an intention to purchase a product according to an exemplary embodiment of the present invention.

Referring to FIG. 3, a user 1 may enter keywords A′, A″, A′″ that are similar to a keyword A related to a product A.

When the user 1 enters the keyword A related to the product A, searches for the product A, and visits a web site that sells the product A based on a search result, an intention parameter may be assumed to be ‘2.’ Additionally, when the user 1 enters the keywords A′ and A″ related to the product A, searches for the product A, visits a web site that sells the product A based on a search result, and adds the product A to a shopping cart of the site, the intention parameter may be assumed to be ‘3.’ Furthermore, when the user 1 enters the keyword A′″ related to the product A, searches for the product A, visits a web site that sells the product A based on a search result, adds the product A to a shopping cart of the site, and purchases the product A, the intention parameter may be assumed to be ‘4.’

As a result, a final value of the intention parameter of the user 1 for the product A may be determined to be ‘12’ by adding values of ‘2,’‘3,’ and ‘4,’ as shown in FIG. 3. When the intention parameter exceeds a predetermined reference value, the user 1 may be identified to be a user with an intention to make a purchase for the product A, and may belong to a user group.

Additionally, the final value of the intention parameter of the user 1 for the product A may be calculated, by applying different weights depending on situations, for example ‘only searching for a product,’ ‘searching for a product and visiting a site,’ ‘searching for a product, visiting a site, and adding the product to a shopping cart,’ and ‘searching for a product, visiting a site, adding the product to a shopping cart, and purchasing the product.’

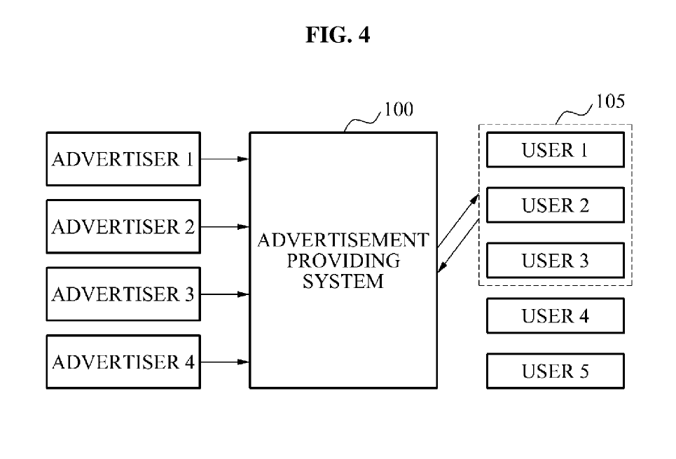

FIG. 4 is a diagram that illustrates a process of providing a user group with an advertisement of an advertiser according to an exemplary embodiment of the present invention.

The advertisement providing system 100 may receive a first bid for a keyword related to a product or service from a plurality of advertisers (for example, advertisers 1 through 4), and may receive a second bid for a keyword related to a user group from the plurality of advertisers.

A maximum bit price among bid prices proposed by the plurality of advertisers during the first bid may be set to be a minimum bid price of the second bid. That is, the plurality of advertisers need to propose a bid amount higher than the minimum bid price.

In FIG. 4, the advertiser 3 is assumed to be an advertiser who has succeeded in the second bid. The advertiser 3 may be authorized to provide a keyword advertisement of the advertiser 3 to a user group 105 identified in association with a product or service, prior to the advertisers 1, 2, and 4. Since the user group 105 includes users with intentions to make a purchase for the product or service, the keyword advertisement of the advertiser 3 may be superior in a targeting effect to keyword advertisements of the other advertisers. Accordingly, sales of the advertiser 3 may be improved.

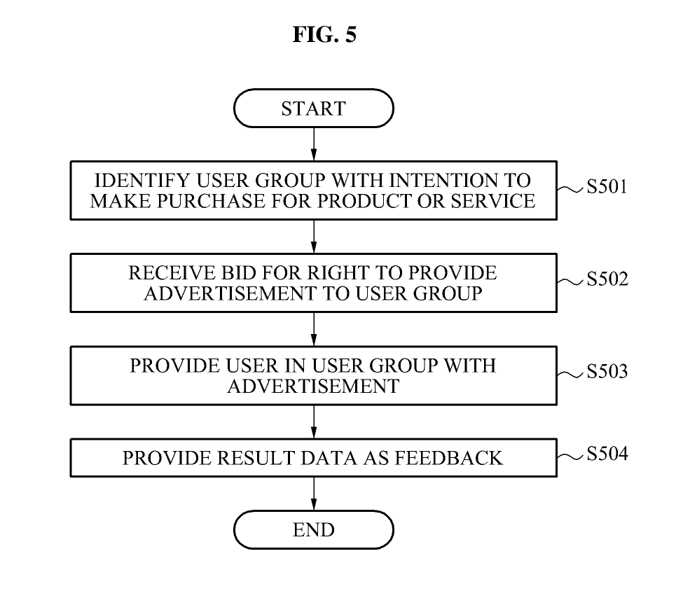

FIG. 5 is a flowchart illustrating an advertisement provision method according to an exemplary embodiment of the present invention.

In operation S501, an advertisement providing system may identify a user group with an intention to make a purchase for a product or service.

In an exemplary embodiment, the advertisement providing system may identify the users in the user group based on search histories of the users for a keyword related to a product or service. In another exemplary embodiment, the advertisement providing system may identify the users in the user group for a product or service, based on at least one of whether at least one similar keyword related to the product or service is repeatedly inputted, and the number of times the similar keyword is repeatedly inputted. In still another exemplary embodiment, the advertisement providing system may identify the user group using conversion data of a user that is based on a search result associated with a keyword related to a product or service.

In operation S502, the advertisement providing system may receive a bid for a right to offer an advertisement to the user group.

Specifically, the advertisement providing system may receive, from one or more advertisers, a first bid for a keyword related to a product or service, and may receive a second bid from the advertisers. Additionally, the advertisement providing system may determine a minimum bid price for the second bid, based on a bid price received through the first bid, and may receive the second bid.

In operation S503, the advertisement providing system may provide a user in the user group with an advertisement of a successful advertiser who has succeeded in the bid, prior to the other advertisements, namely, advertisements of unsuccessful advertisers who have failed in the bid. In this instance, the advertisement providing system may arrange advertisements so that the advertisement of the successful advertiser may rank higher than the other advertisements.

In operation S504, the advertisement providing system may provide, as feedback, with result data regarding a result that the user in the user group purchases a product or service of the successful advertiser through an advertisement provided to the user group. In this instance, the advertisement providing system may utilize conversion data of the user provided with the advertisement of the successful advertiser, as basic data to determine an intention to make a purchase for a product or service.

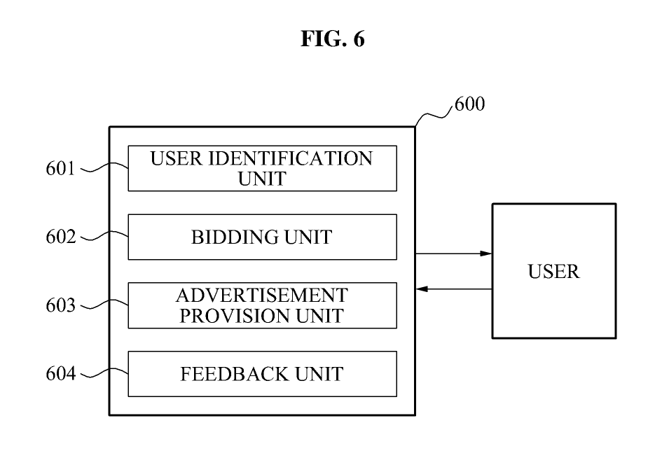

FIG. 6 is a block diagram that illustrates another configuration of an advertisement providing system 600 according to an exemplary embodiment of the present invention.

Referring to FIG. 6, the advertisement providing system 600 may include a user identification unit 601, a bidding unit 602, an advertisement provision unit 603, and a feedback unit 604.

The elements illustrated in FIG. 6 are substantially similar to those illustrated in FIG. 1 except that the user group identification unit 101 is replaced with the user identification unit 601. Detailed descriptions of other elements, therefore, will be omitted for simplicity of the description. If not specifically described, the detailed description of FIG. 1 will apply to the equivalent elements of FIG. 6.

The user identification unit 601 may identify a user with an intention to make a purchase of a product or service. Whether a user has an intention to make a purchase may be determined based on an intention parameter which is calculated based on the user's actions in relation with the specific product or service. For example, when a user merely searches for the product or service, and actually does not purchase the product or service, the user may be determined to not have an intention to make a purchase. Additionally, when the user searches for the product or service, and purchases the product or service, the user may be determined to have an intention to make a purchase. The intention to make a purchase may be calculated by stages in a purchase process.

In an exemplary embodiment, the user identification unit 601 may calculate the intention parameter, which is used to determine whether the user has an intention to make a purchase of a product or service, based on search history of the user for a keyword related to a product or service. Specifically, when the user enters a keyword related to a product or service and searches for the product or service multiple times, the user is more likely to have an intention to make a purchase of the product or service. Additionally, when a user enters a keyword related to a product or service and selects a shopping category from a search result, the user is more likely to have an intention to make a purchase of the product or service. Furthermore, when a user enters a keyword related to a product or service, and clicks on a sale posting on a community site in which used items are traded, the user is more likely to have an intention to make a purchase of the product or service.

In another exemplary embodiment, the user identification unit 601 may calculate the intention parameter based on at least one of whether at least one similar keyword related to the product or service has been repeatedly inputted, and the number of times the similar keywords have been repeatedly inputted.

In still another exemplary embodiment, the user identification unit 601 may calculate the intention parameter using conversion data of the user that is based on a search result associated with a keyword related to the product or service. The conversion data may include information on a series of user's actions to purchase the product or service. The user's actions may include, for example, (1) logging into a retailer website, (2) subscribing to the retailer site, (3) viewing customer comments or reviews of the products or services on the retailer site, (4) recommending the product or service, a user desires to purchase, to friends on a social network, (5) scraping details of a desired product or service from the retailer site to a community site, (6) adding the product or service to a wish list of the retailer site, (7) adding the product or service to a shopping cart of the retailer site and paying for the product or service with a payment method, and the like.

To identify whether the user has an intention to make a purchase of the product or service, the user identification unit 601 may use identification information to identify the users such as cookie information, an Internet Protocol (IP) information, log-in information, and Media Access Control (MAC) information.

According to an exemplary embodiment, the user identification unit 601 may have a purchase intention database which contains a plurality of products and services and associated threshold intention parameters therewith. The user identification unit 601 first calculates the intention parameter of a particular user for a specific product or service as described above. The user identification unit 601 then retrieves the associated threshold intention parameter from the purchase intention database. The associated threshold intention parameter functions as a threshold value of the particular product or service. The user identification unit 601 may compare the calculated intention parameter with the associated threshold intention parameter to determine whether the user has an intention to make a purchase. The user identification unit 601 may determine that the user has an intention to make a purchase if the calculated intention parameter of the user is greater than the associated threshold intention parameter for the specific product or service. The user identification unit 601 may determine that the user does not have an intention to make a purchase for the product or service if the calculated intention parameter of the user is less than the associated threshold intention parameter.

In another exemplary embodiment, instead of or in addition to the purchase intention database, the user identification unit 601 has a certain threshold value for determining the existence of an intention to purchase regardless of a specific product or service. For example, the user identification unit 601 has a threshold value of ‘10’ for determining the existence of such intention. In such case, the user identification unit 601 may determine that the user has an intention to make a purchase if the calculated intention parameter of the user is greater than the threshold value, ‘10’ regardless of the product or service. Similarly, the user identification unit 601 may determine that the user does not have an intention to make a purchase for the product or service if the calculated intention parameter of the user is less than the threshold value, ‘10’ regardless of the product or service.

According to exemplary embodiments of the present invention, it is possible to identify a user group with an intention to make a purchase for a product or service, and to increase a targeting effect for a keyword advertisement of an advertiser.

Additionally, according to exemplary embodiments of the present invention, it is possible to perform a bid between advertisers with respect to an identified user group, and to grant a right to provide a keyword advertisement to a successful advertiser who has succeeded in the bid, prior to the other advertisers, thereby to naturally induce a competitive bid to achieve an excellent advertising effect.

Furthermore, according to exemplary embodiments of the present invention, it is possible to identify a user group with an intention to make a purchase for a product or service, based on a search history, information regarding repeatedly inputting of a keyword, and conversion data, thereby to more accurately determine a user group with an intention to make a purchase for a product or service.

The exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for providing an advertisement using a processor, the method comprising:
identifying a user, by the processor, with an intention to make a purchase;
receiving a bid for a right to offer an advertisement of an advertiser for a product or service to the user;
storing an identification (ID) of the advertisement into an advertisement database contained in a storage device; and
providing the user with the advertisement of the advertiser.

2. The method of claim 1, wherein the identifying of the user comprises identifying the user based on a search history for a keyword related to the product or service.

3. The method of claim 1, wherein the identifying of the user comprises identifying the user corresponding to the product or service, based on at least one of whether at least one similar keyword related to the product or service is repeatedly inputted, and a number of times the similar keyword is repeatedly inputted.

4. The method of claim 1, wherein the identifying of the user comprises identifying the user using conversion data of the user that is based on a search result associated with a keyword related to the product or service.

5. The method of claim 1, wherein the receiving of the bid comprises:
receiving, from one or more advertisers, a first bid for a keyword related to the product or service; and
receiving a second bid from the one or more advertisers.

6. The method of claim 5, wherein the receiving of the bid comprises determining a minimum bid price for the second bid based on a bid price received through the first bid, and receiving the second bid.

7. The method of claim 1, further comprising:
providing, as feedback, result data regarding a result that the user purchases a product or service of a successful advertiser who succeeded in the bidding through the advertisement provided to the user.

8. The method of claim 7, wherein the providing of the result data comprises utilizing conversion data of the user provided with the advertisement of the advertiser to determine the intention to make a purchase.

9. The method of claim 1, wherein the providing of the advertisement comprises arranging advertisements so that an advertisement of a successful advertiser who succeeded in the bidding ranks higher than advertisements of other advertisers.

10. A system for providing an advertisement, the system comprising:
a user identification unit to identify a user with an intention to make a purchase;
a bidding unit to receive a bid for a right to offer an advertisement of an advertiser for a product or service to the user;
a storage device to contain an advertisement database to store an identification (ID) of the advertisement; and
an advertisement provision unit to provide the user with the advertisement of the advertiser.

11. The system of claim 10, wherein the user identification unit identifies the user based on a search history for a keyword related to the product or service.

12. The system of claim 10, wherein the user identification unit identifies the user corresponding to the product or service, based on at least one of whether at least one similar keyword related to the product or service is repeatedly inputted, and a number of times the similar keyword is repeatedly inputted.

13. The system of claim 10, wherein the user identification unit identifies the user using conversion data of the user that is based on a search result associated with a keyword related to the product or service.

14. The system of claim 10, wherein the bidding unit receives, from one or more advertisers, a first bid for a keyword related to the product or service, and receives a second bid from the one or more advertisers.

15. The system of claim 14, wherein the bidding unit determines a minimum bid price for the second bid based on a bid price received through the first bid, and receives the second bid.

16. The system of claim 10, further comprising:
a feedback unit to provide, as feedback, result data regarding a result that the user purchases a product or service of a successful advertiser who succeeded in the bidding through the advertisement provided to the user.

17. The system of claim 16, wherein the feedback unit utilizes conversion data of the user provided with the advertisement of the advertiser to determine an intention to make a purchase.

18. The system of claim 10, wherein the advertisement provision unit arranges advertisements so that an advertisement of a successful advertiser who succeeded in the bidding ranks higher than advertisements of other advertisers.

19. A non-transitory computer readable recording medium storing a program to cause a computer to implement the method of claim 1.
